(19) United States
(12) Patent Application Publication
(10) Pub. No.: US 2011/0093560 A1
(43) Pub. Date: Apr. 21, 2011

(54) MULTI-NONLINEAR STORY INTERACTIVE CONTENT SYSTEM

(75) Inventor: Guy Brian Morris, Bellevue, WA (US)

(73) Assignee: IVOICE NETWORK LLC, Sammamish, WA (US)

(21) Appl. No.: 12/581,668

(22) Filed: Oct. 19, 2009

(51) Int. Cl. G06F 15/16; G06F 17/30

(52) U.S. Cl. 709/217; 709/231; 707/E17.009

(57) ABSTRACT

Techniques for generating a social community system based around multi-nonlinear stories is herein disclosed.

### BACKGROUND

Traditional models of plot and character driven narratives, including books and other print, television or film have operated on the broadcast, i.e., one to many, paradigm. This managed narrative model is based on narratives that collapse or condense stories, key events, and key characters into a single perspective. In many cases, this approach is taken to reduce the amount of time it would take to tell or watch a story. The byproduct of this approach, however, is that these stories are all based around a small set of characters within the story, with small appearances by secondary characters. While many more characters may be introduced in part, or in brief glimpses, these characters, their perspectives of the scene in which they appear, or their ongoing stories are never revealed. The traditional model, therefore typically limits primary character voices and key events. For example, a story of a war will not deal with the thousands or millions of people involved in the war, but may take a small set of voices and experience the war through selective eyes, perspectives or voices.

Professionally produced shows conforming to this narrative model typically follow some form of what is known as a story arc, which takes the viewer or reader through a transition from introduction or story set-up, to story or character conflict, and then to story or character resolution/transition. In the case of serial stories (film, television, or print), these professionally produced shows are continuous and provide a consistent context such as plot-themes, character types, or show culture, the viewer merely watches the story unfold and does not have a character voice, e.g., the ability to add to the experience.

Social networking sites, on the other hand, are communities that allow members to create original content, as well as share content and interact with each other. Social network technologies can range from the ability to create a personal home page, share media, post and receive comments regarding personal interests, or other options. Social networks thus present models to extend relationships and connect with others. However, all of the social networks are static and offer no compelling event or entertainment content that refreshes frequently that can pull the audience back into the site on a daily basis. To date, none of these exchanges have supported structure character, plot, story, or other entertainment content.

### SUMMARY

An example embodiment of the present disclosure describes an operational procedure. In this example, the operational procedure includes, but is not limited to receiving a selection of a cast member object; receiving a script object; assembling a scene beat object by linking the selected cast member object to the received script object; and assembling a scene object from the scene beat object and at least one other scene beat object. In addition to the foregoing, other aspects are described in the claims, drawings, and text forming a part of the present disclosure.

An example embodiment of the present disclosure describes an operational procedure. In this example, the operational procedure includes, but is not limited to streaming a professionally produced show to a remote computing system; and sending a story formed from a scene object to the remote computing system, wherein the story formed from the scene object exists in an environment of the professionally produced show. In addition to the foregoing, other aspects are described in the claims, drawings, and text forming a part of the present disclosure.

An example embodiment of the present disclosure describes an operational procedure. In this example, the operational procedure includes, but is not limited to storing the scene object; and receiving a selection of a cast member object to fill an unfilled role in a scene object. In addition to the foregoing, other aspects are described in the claims, drawings, and text forming a part of the present disclosure.

An example embodiment of the present disclosure describes an operational procedure. In this example, the operational procedure includes, but is not limited to publishing a professionally produced episode of a show that includes a global event; and linking a scene object to the produced episode of the show, wherein the scene object describes a story that takes place during the global event. In addition to the foregoing, other aspects are described in the claims, drawings, and text forming a part of the present disclosure.

It can be appreciated by one of skill in the art that one or more various aspects of the disclosure may include but are not limited to circuitry and/or programming for effecting the herein-referenced aspects of the present disclosure; the circuitry and/or programming can be virtually any combination of hardware, software, and/or firmware configured to effect the herein-referenced aspects depending upon the design choices of the system designer.

The foregoing is a summary and thus contains, by necessity, simplifications, generalizations and omissions of detail. Those skilled in the art will appreciate that the summary is illustrative only and is not intended to be in any way limiting.

### BRIEF DESCRIPTION OF THE DRAWINGS

FIG. 1 depicts an example non-linear, multi-voice narrative model.

FIG. 2 describes an example entertainment paradigm.

FIG. 3 depicts an example computer system.

FIG. 4 depicts an example multiple-narrative content distribution system.

FIG. 5 depicts an example organizational layout for an example story generated by the multiple-narrative content distribution system.

FIG. 6 depicts example webpages that can be generated by the multiple-narrative content distribution system.

FIG. 7 depicts an operational procedure.

FIG. 8A depicts an alternative embodiment of the operational procedure of FIG. 7.

FIG. 8B depicts an alternative embodiment of the operational procedure of FIG. 7.

FIG. 9 depicts an operational procedure.

FIG. 10 depicts an alternative embodiment of the operational procedure of FIG. 9.

FIG. 11 depicts an operational procedure.

FIG. 12 depicts an alternative embodiment of the operational procedure of FIG. 11.

FIG. 13 depicts an operational procedure.

### DETAILED DESCRIPTION

The herein described techniques can be used to implement a multi-nonlinear story interactive content distribution system that allows for viewers of a professionally produced show to become cast members and add to the show's environment. The herein described system can conform to a new narrative model that includes managed narratives, e.g., professionally produced shows, interconnected with one or more cast narratives, e.g., user created content.

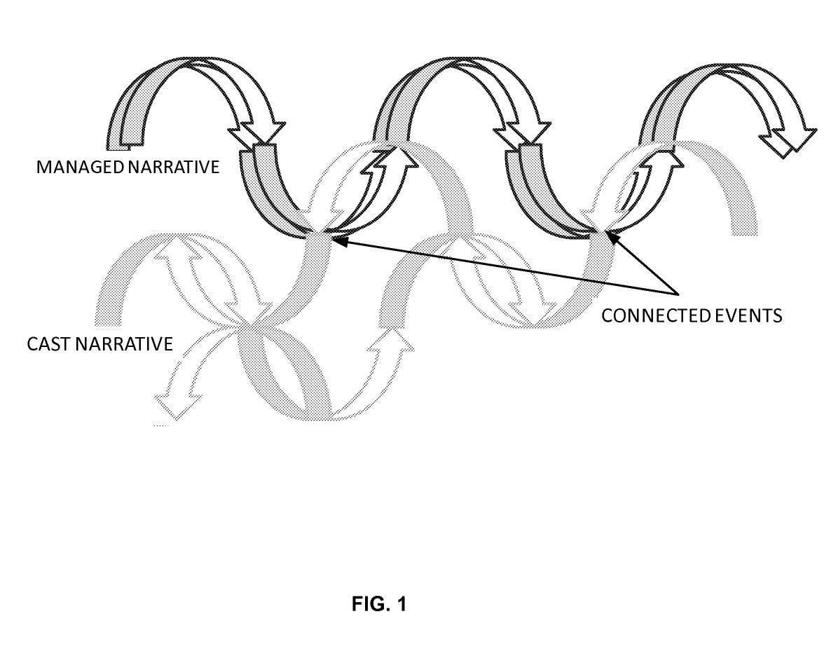

Turning to FIG. 1, it shows different streams that represent story arcs of managed and cast narratives. As one of skill in the art can appreciate, the depicted crests and troughs can represent story arcs, e.g., characters moving from one state to another in a story. For example, the crests can represent how characters fall from grace and troughs can represent how characters overcome adversity. Continuing with the overview of FIG. 1, the managed narrative stream, e.g., a professionally produced show, can represent a story told according to the traditional model described above and the cast narrative streams, e.g., user created narratives, can represent user created content added to the professionally produced show that tell stories about characters that may not be in the managed narrative. Moreover, since the cast narratives are user created, the model provides an interactive experience for audience members.

The combination of managed narratives along with the cast narratives presents a model that is similar to the way true stories are experienced by real people in real life. Or put another way, cast narratives allow each character to have a story, even characters that don't have a voice in the managed narrative. As shown by the figure, both narratives can arc and in some situations cross during events that are shared between cast member characters and managed narrative characters. For example, the main character of a managed narrative may go to a zoo and have a conversation with a tour guide working at the zoo who happens to be a user created cast member. The contact between the main character and the tour person may be insignificant to the plot of the managed narrative, however the tour guide has their own story to tell and their own perspective of the conversation that can be told in a user created story.

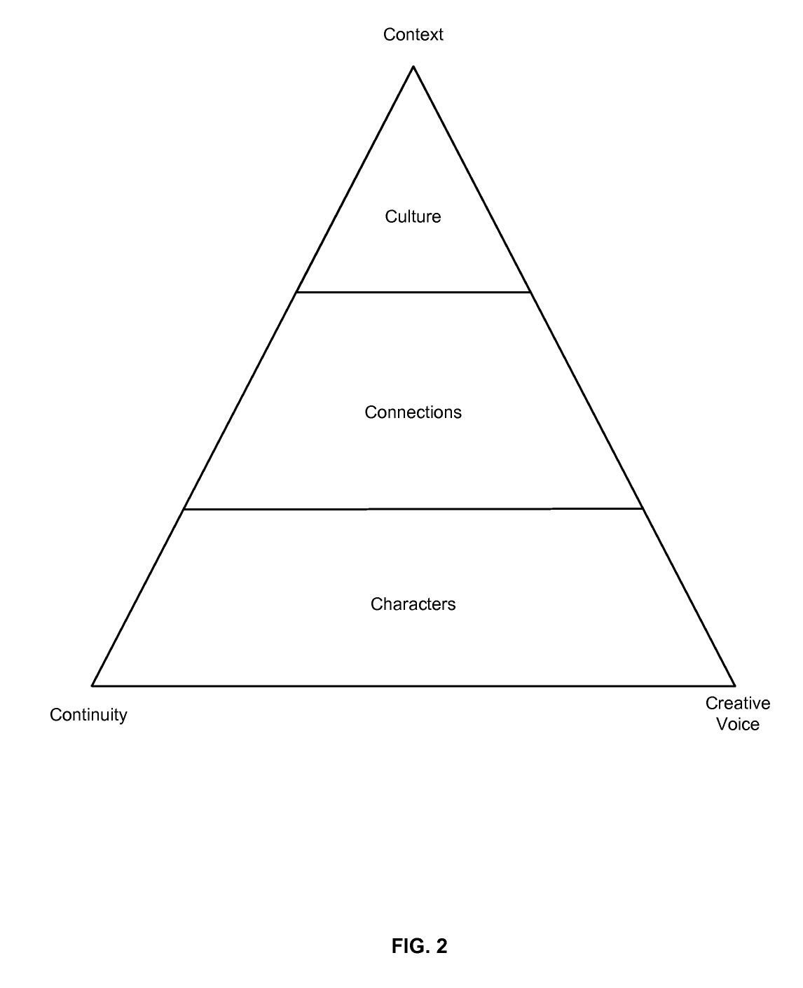

In an embodiment, and turning to FIG. 2, the cast narratives, e.g., user stories, can be developed in order to flesh out the worlds in which professionally produced shows exist according to a paradigm for viewing and interacting with multimedia content. Or put another way, the paradigm can be used to ensure that the user created stories fit within the context of the show, continue the show, and allow audience members to have a creative voice within the show.

Context is a primary property of the new paradigm and includes the genre, settings, tones, styles, and pace of entertainment content created by users. In relation to the herein described system, context rules can be used to ensure that user created stories fit with the professionally produced show. Or put another way, a professionally produced show may have a culture built around it and context rules can be used to extend that culture to user created content. For example, the culture of a CSI® series is predictably different than the culture of the Seinfeld® series in that a viewer would expect certain things to happen in a Seinfeld episode that would not happen in a CSI® episode.

Creative voice (as opposed to a social-chat voice or commentary-blog voice) is another foundational property in the paradigm. Creative voice is the ability of a user to add to a story. In example embodiments of the present disclosure the herein described system can be configured to allow a user to directly impact the professionally produced show by creating stories and characters within the professionally produced show's environment. Referring to the zoo example above, creative voice is what allows a user to tell the tour guide's story.

Continuity rules capture the development of both storylines and characters. Continuity based rules define the ability for plots and characters to develop and continue over multiple scenes, episodes, and series. For example continuity allows for the flow like stories illustrated in FIG. 1 to exist.

Each property can rely on and reinforce each other as context drives development of a show's culture, which influences creation of characters. As users are given a true creative voice they extend the storylines within the show's context through characters. Characters, which have a creative voice within the context, are positioned to connect with other characters to reinforce storylines and character continuity.

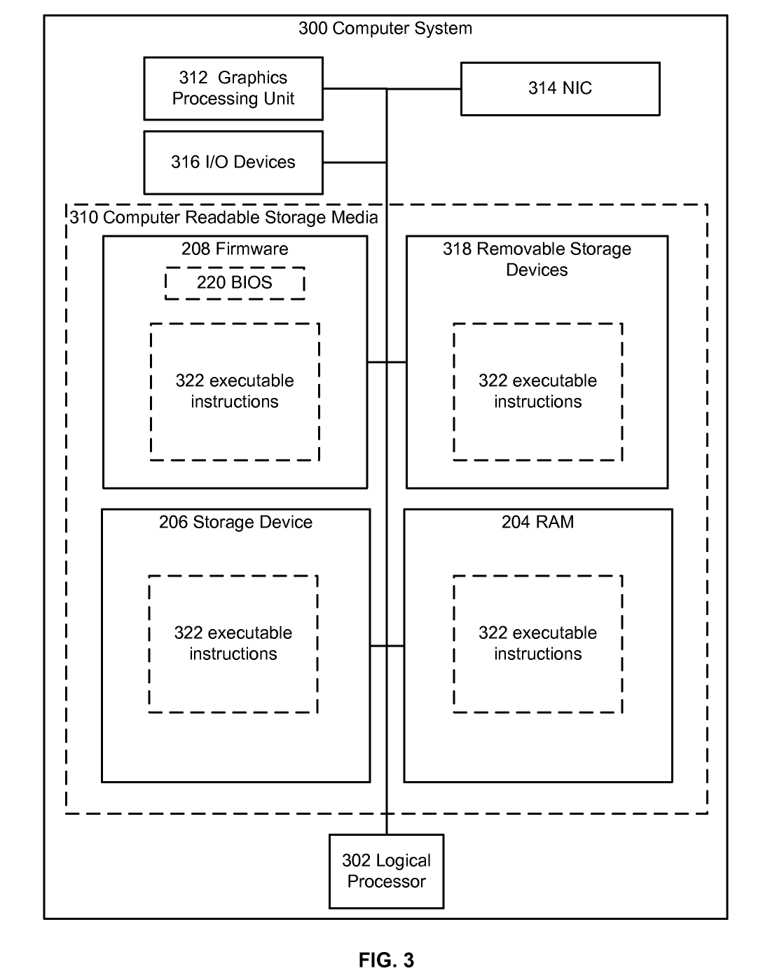

FIG. 3 illustrates an example computing environment in which the disclosure may be implemented. The computing system 300 can be configured using techniques described below to effectuate a content distribution system that includes circuitry configured to allow users to add to professionally produced shows in a structured and controlled way in order to extend the show's story.

The term circuitry used throughout the disclosure can include hardware components such as application-specific integrated circuits (ASICs), hardware interrupt controllers, hard drives, network adaptors, graphics processors, hardware based video/audio codecs, alone or in combination with the firmware/software used to operate such hardware. The term circuitry can also include microprocessors configured to perform function(s) by firmware, by switches, and/or one or more logical processors, e.g., one or more cores of a multi-core general processing unit. The logical processor(s) and the like can be configured by software instructions embodying logic operable to perform function(s) that are loaded from memory, e.g., RAM, ROM, firmware, etc. In example embodiments where circuitry includes a combination of hardware and software an implementer may write source code embodying logic that is subsequently compiled into machine executable code that can be executed by a logical processor, a microprocessor, or the like. Since one skilled in the art can appreciate that the state of the art has evolved to a point where there is little difference between hardware, software, or a combination of hardware/software, the selection of hardware versus software to effectuate functions is merely a design choice. Thus, since one of skill in the art can appreciate that a software process can be transformed into an equivalent hardware structure, and a hardware structure can itself be transformed into an equivalent software process, the selection of a hardware implementation versus a software implementation is left to an implementer.

Referring now to FIG. 3, an exemplary computing system 300 is depicted. Computing system 300 can include a logical processor 302, e.g., an execution core. While one logical processor 302 is illustrated, in other embodiments computing system 300 may have multiple logical processors, e.g., multiple execution cores per processor substrate and/or multiple processor substrates that could each have multiple execution cores. As shown by the figure, various computer readable storage media 310 can be interconnected by one or more system busses which couples various system components to the logical processor 302. The system buses may be any of several types of bus structures including a memory bus or memory controller, a peripheral bus, and a local bus using any of a variety of bus architectures. In example embodiments the computer readable storage media 310 can include for example, random access memory (RAM) 304, storage device 306, e.g., electromechanical hard drive, solid state hard drive, etc., firmware 308, e.g., FLASH RAM or ROM, and removable storage devices 318 such as, for example, CD-ROMs, floppy disks, DVDs, FLASH drives, external storage devices, etc. It should be appreciated by those skilled in the art that other types of computer readable storage media can be used such as magnetic cassettes, flash memory cards, digital video disks, and Bernoulli cartridges.

The computer readable storage media can provide non volatile storage of executable instructions 322, data structures, program modules and other data for the computer 300. A basic input/output system (BIOS) 320, containing the basic routines that help to transfer information between elements within the computer system 300, such as during start up, can be stored in firmware 308. A number of programs may be stored on firmware 308, storage device 306, RAM 304, and/or removable storage devices 318, and executed by logical processor 302 or ASICs.

Commands and information may be received by computing system 300 through input devices 316 which can include, but are not limited to, a keyboard and pointing device. Other input devices may include a microphone, joystick, game pad, scanner or the like. These and other input devices are often connected to the logical processor 302 through a serial port interface that is coupled to the system bus, but may be connected by other interfaces, such as a parallel port, game port or universal serial bus (USB). A display or other type of display device can also be connected to the system bus via an interface, such as a video adapter which can be part of, or connected to, a graphics processor 312. In addition to the display, computers typically include other peripheral output devices (not shown), such as speakers and printers. The exemplary system of FIG. 3 can also include a host adapter, Small Computer System Interface (SCSI) bus, and an external storage device connected to the SCSI bus.

Computing system 300 may operate in a networked environment using logical connections to one or more remote computers, such as a remote computer. The remote computer may be another computer, a server, a router, a network PC, a peer device or other common network node, and typically can include many or all of the elements described above relative to computing system 300.

When used in a LAN or WAN networking environment, computing system 300 can be connected to the LAN or WAN through a network interface card 314 that can include its own processor. The NIC 314, which may be internal or external, can be connected to the system bus. In a networked environment, program modules depicted relative to the computing system 300, or portions thereof, may be stored in the remote memory storage device. It will be appreciated that the network connections described here are exemplary and other means of establishing a communications link between the computers may be used. Moreover, while it is envisioned that numerous embodiments of the present disclosure are particularly well-suited for computerized systems, nothing in this document is intended to limit the disclosure to such embodiments.

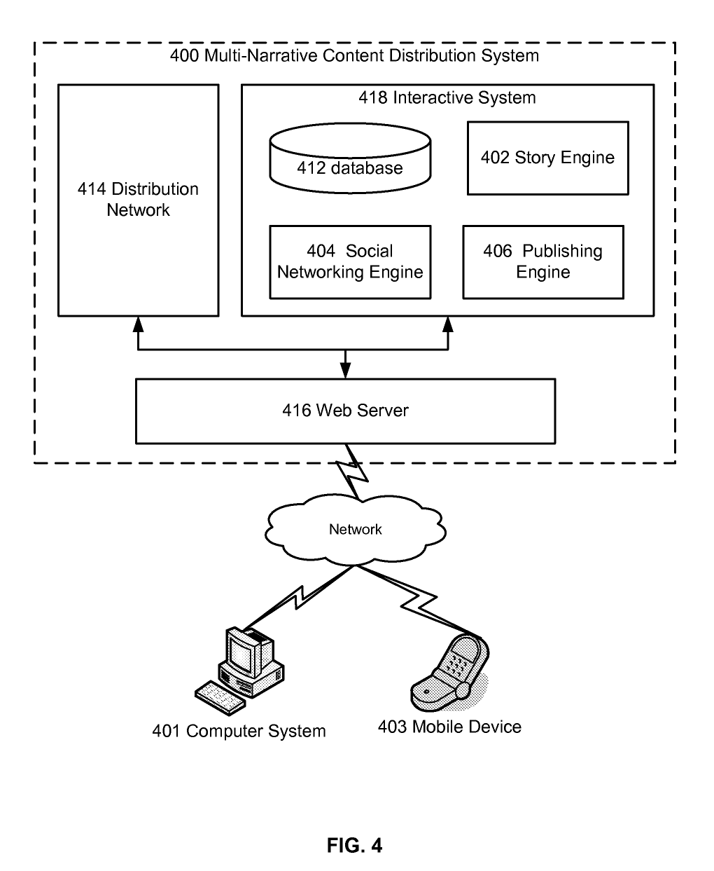

Turning to FIG. 4, a multiple-narrative interactive content distribution system (“the content system” or simply “the system”) 400 is illustrated. The content system 400 can include components similar to computing system 300 of FIG. 3, and is illustrated in dashed lines which is indicative of the fact that the content system 400 can be effectuated by different physical architectures than the one depicted. For example, the system 400 could be effectuated by distributed architecture where different physical computer systems spread over a large area, e.g., the world, are configured to perform the various herein described functions. For example, a story engine 402 may be effectuated by different physical computer system than publishing engine 406. In addition, one of skill in the art can appreciate that a single computer system could effectuate the entire system 400, e.g., distribution network 414 could be effectuated by the same computer system as the content system 400. The content system 400 can be effected by server side and client side components. For example, features of the content system 400 can be accessed via webpages that can be sent to remote computing systems such as a computer system 401 and/or a mobile device 403 (each can have an associated user). The webpages can use client side plug-in and the like and can be static or dynamic. For example, client side circuitry such as Asynchronous JavaScipt and XML (AJAX) could be used to enhance the user experience by asynchronously sending and receive data from web server 416. Moreover, database 412 can include one or more physical databases that can be, for example, implemented by SQL database engines or the like.

Broadly, the content system 400 can be configured to implement a content distribution network that that allows users to interact with the shows they watch. For example, the content system 400 can be used to expand the ability of a user to interact with content by allowing the user to add his or her creative voice to a show, add continuity by linking user-created characters to a show's environment and have the same style as the show to ensure that the context is the same.

As shown by the figure, a broadcast distribution network 414 can execute that includes multiple channels of entertainment content, e.g., drama channels, sports channels, romantic comedy channels, etc., that are professionally produced shows, e.g., a network TV show such as Friends®. The distribution network 414 can include a media server that can stream content to IP addresses associated with computing systems such as a mobile device 403 or computer system 401.

The interactive system 418 includes various circuitry that can effectuate the interactive process. Briefly, the story engine 402 can be configured to assemble stories together from multimedia objects such as video, script, audio, etc. Example multimedia objects can be provided by the story engine 402 and customized by an author to include information indicative of story elements such as characters, plot, conflict, and setting. The social networking engine 404 can be configured to effectuate an interactive community of user made cast members for a particular show that is broadcasted on the distribution network 414 and publishing engine 406 to make the story available to the public.

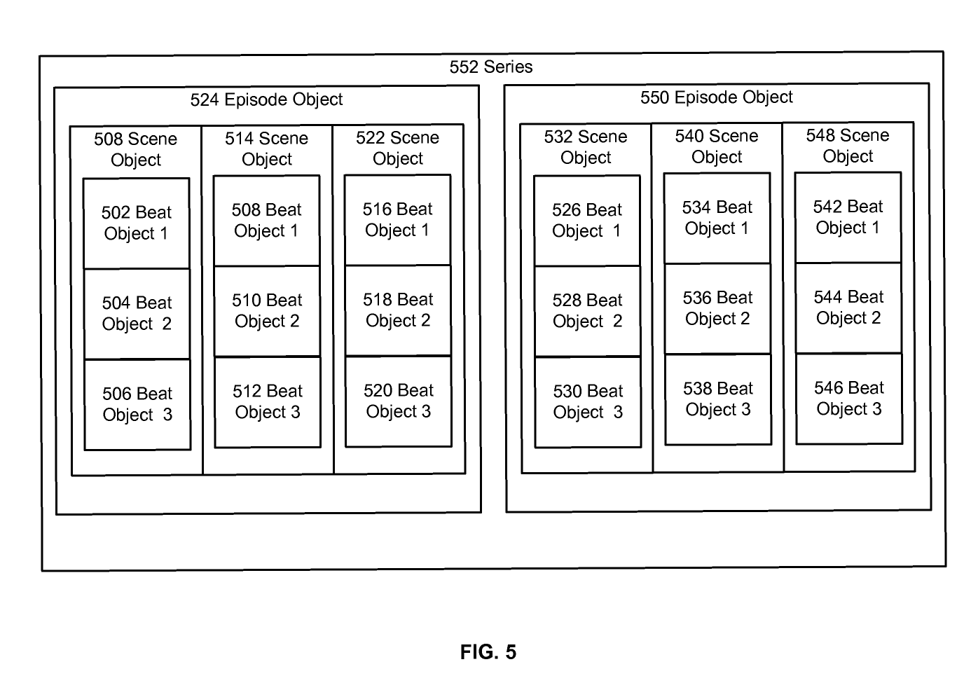

Referring now to the story engine 402, it can be configured to drive the story generation process. For example, authors can use the story engine 402 to cerate stories that can exist in a particular show's environment or as stories that are disconnected from any show. A story can be broken up into discrete elements that can be assembled by the story engine 402 into content that is indicative of a story when played for a viewer (a user that views the story). For example, and turning to FIG. 5, a story could be told by the content that forms a single scene object such as scene object 508. Briefly, scene objects can be thought of as being equivalent in duration and substance to a television scene, e.g., each scene can have an introduction, something that causes conflict, and something that resolves the conflict or transitions the scene to the next scene. In addition to single scene stories, stories can also be told by the content of a plurality scene objects (scene objects 508, 514, and 522) that are assembled into an episode object 524. In another example stories could be told by a plurality of episode objects (episodes 524 and 550) and linked together to form a series 550. Thus, the choice of whether the story will be told in a series, episode, or scene is left up to the user.

As shown by the figure, each scene object is made from one or more scene beat objects (beat objects 502-506, 508-512, 516-520, 528-532, 536-540, and 542-546). The scene beat objects can be considered the fundamental unit used to create a story because the scene beat objects can include the content, e.g., multimedia objects such as script, video, audio, and the like that form the story.

In a preferred example embodiment, the story engine 402 can be configured to require that each scene object 508 include three beat objects to ensure that each scene flows. In an embodiment the three-beat-per-scene requirement is preferred and constitutes the best mode of practicing the disclosure because it forces authors that may have little or no experience creating stories into a common story telling format. For example, stories typically include three components in each scene (a beginning, middle, and an end) and there are story elements that are typically expected in each part of a scene. For example, some sort of conflict typically appears in the middle of a scene. The three beat-per-scene requirement can be used by the story engine 402 can be configured to outline each scene for a user while leaving the important creative decisions such as what the plot is, who is starring in the story, etc., to the author. For example, a beginning scene beat object can introduce the scene, e.g., introduce the character(s) and/or the setting. The middle scene beat object can introduce a conflict, e.g., conflict between characters, conflict within a character, and/or conflict between an external force such as nature or the supernatural. The end scene beat object can resolve the conflict or transition the scene to another scene. While the preferred embodiment includes three-beats-per-scene, it is contemplated that the disclosure can be practiced with scenes include more or less scene beats. For example, a scene including five beats (introduction (1), conflict (2), introduction of additional characters (3), intervening addition of conflict (4), and transition (5)) is contemplated. Thus, the disclosure is not limited to scenes with three-beats-per-scene.

The multimedia objects used to tell the story can be obtained from a variety of places and each object can be tagged with metadata that enables a search engine to locate them in the database 412 in response to a user initiated search or during a scene building process. In an example embodiment the multimedia objects can be created by developers associated with the professionally produced show and stored the database 412. In this example the developers of the show can tailor the type of content that can be used in user created shows in order to enforce a single context for the show (the professionally produced show) and the user community stories. An example of professionally developed content may include video backdrops that can be downloaded by the user. A user may use a portable green screen device to digitally insert themselves into the video and upload it to the database 412. Thus, in an example embodiment a user could insert themselves into the background of a scene in the professionally produced show and use it in their own story. In the same, or another embodiment the multimedia content can include content that is generated and uploaded by a user. For example, a user can shoot their own video or create their own audio and upload it to the database 412. Or in another example a user could direct a computer animated avatar through specific activities and dialogue into the background of a scene in the professionally produced show and use it in their own story.

The story engine 402 can be configured to enforce rules during the story creation process by being configured to allow (or prevent) certain multimedia content from being inserted into scene beat objects and the like. The story engine 402 thus can enforce data rules that force users to create stories in ways that allow them to be creative, but also provide a good experience for other users. For example, the rules can be set by an administrator associated with a professionally produced show in which the user created stories exist in order to make sure that user created stories include themes appropriate for the show.

One way that the data rules can be enforced is through the use of templates. For example, when an author interfaces with the story engine 402 he or she can use a story creation “wizard” process that can be configured to have the user outline his or her story. Based on the author input the story engine 402 can suggest plots for the story. In an example embodiment the list of plots can be created by content producers associated with the professionally produced show. Once a plot scenario is selected in an embodiment the story engine 402 can be configured to suggest scene scenarios for each scene in the story to build a story having the desired plot. The scene scenarios can also be created by the content producers associated with the professionally produced show. Once individual scene scenarios are selected the story engine 402 can use the information provided by the author to search a database 412 of multimedia objects that are appropriate for the plot.

In a specific example, a scene scenario can be thought of as a type of scene that one would expect in a show with a certain theme. Scene scenarios that would be appropriate for a romantic comedy based in New York City may include scenarios that describe walking in Central Park, taking a cab around the city, visiting the Statute of Liberty, etc. Example scenarios that match an espionage show based in London may include scenarios that describe a clandestine meeting at night, a car chase, finding a dead body, breaking into a building, etc.

Each scene scenario can be mapped via metadata to a collection of script templates, video objects, and/or audio objects. For example, if an author selects a plot scenario “espionage story based in London” and indicates that the story is to be three scenes long, the author may be presented with three groups of scene scenarios, each scene scenario including script templates and video that can be used to illustrate the scene. An author could select from the different templates and use them to populate the scene beat objects to form the scene. In a specific example, the selection of the “espionage story based in London” scenario could return multiple different types of template scripts that provide an introduction for the scene, conflict for the scene, and ways to resolve the conflict and/or transition to another scene. In a more specific example the author could be presented with a list of multiple scenarios for each scene such as “meeting an arms dealer,” “chaos of war,” or “hidden terrorist cache.” Each scene scenario may include different script templates, video objects, audio objects, etc. For example an audio object for “meeting an arms dealer” may include bar background noise whereas an audio object for the “chaos of war” may include explosions and gun fire.

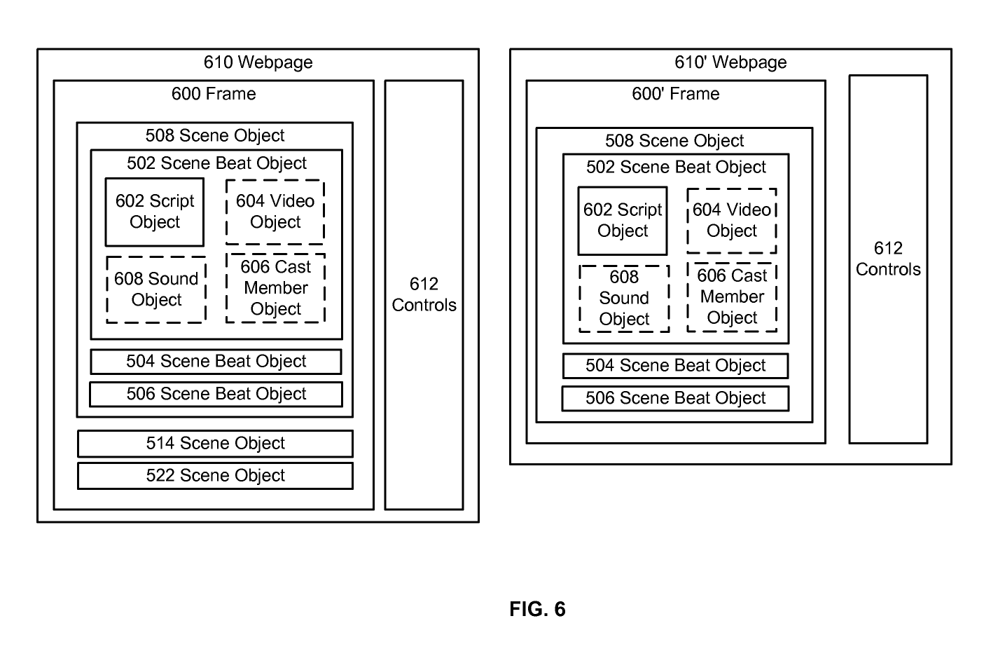

Turning to FIG. 6, in an embodiment the user can interface with the story engine via a web based interface. When an author logs onto the content system 400 he or she can decide to create a story and select a link to the “story engine 402.” The web server 416 can send back a webpage 610 or 610′ that can be used by the author to create the story by manipulating data objects. Briefly, webpage 610 and 610′ are different ways that an author can be presented with a story engine interface and the disclosure is not limited to any particular webpage arrangement.

As shown by the figure, the webpage (610 or 610′) can include a frame (600 or 600′) which can be though of as a canvas to create a story on. Generally, an author can interact with the story engine 402 and generate a story via the frame 600. For example, FIG. 6 shows an exploded view of a scene object 508 and a scene beat object 502. In this example the author use controls 612 to indicate that he or she would like to create a scene. The frame 600 could load a scene object 508 and the author could then select how many beats he or she would like in the scene. The author could manually edit each scene beat object by opening them and changing the content of the script object 602, change the video and/or audio objects 604 and/or 608, or change the cast member object 606 in the scene beat object 502. (Script object 602, video and audio objects 604 and 608, and cast member object(s) 606 are indicated in dashed lines which indicate that in embodiments a completed scene beat object may have none or some of the depicted story elements). When the author is satisfied with the content of the scene object 508 he or she can save it and a copy of the content in the frame 600 can be sent to the story engine 402 for processing. For example, controls 612 may include a save button that when pressed sends packets of information to the story engine 402 to save the content of the frame 600. In another example the webpage (610 or 610′) can asynchronously save portions of the frame 600 by asynchronously sending packets indicative of some, or all of the content in the frame 600 based on predetermined criteria such as length of time, or whether an author interacts with the frame.

Turning back to FIG. 4, also illustrated is the social networking engine 404 which can manage the interactive community that exists around one or more professionally produced show in the distribution network 414. The social networking engine 404, e.g., hardware and/or a combination of hardware and software, can be configured to allow user members to create and maintain cast members that exist in the professionally produced show's environment, user created cast member groups, and connect with other members in the show's environment.

One way that the social networking engine 404 allows for interactivity is via a social networking website. For example, the social networking engine 404 can be configured to effectuate friend lists, chat rooms, and email, for the users to interact, network, and collaborate on stories. In addition, a user can access the social networking website and create a cast member is a user profile for a fictional character, e.g., a person in a narrative or work of art, that can be added to stories created by user members or producers of the professionally produced show. The profile can describe who the cast member is and what relationships they have to other cast members or groups.

The social networking engine 404 can additionally control and maintain forums, blogs, etc., that can be used to allow users to discuss the professionally produced show and the user created stories. The social networking engine 404 can allow users to rate the user content shows. For example, members can post to a forum to gossip about their favorite characters and rate them. Additionally members can blog, critique, and rate shows. In at least one example embodiment user created stories and characters with high ratings have their stories and characters added to the professionally produced show. In this example the producers of the professionally produced show can add to the main story using the user created world that has been formed. For example, a user created spy character that has a popular fan base could be added to the main show in the instance that the producers of the show need a spy character that has user created character's traits. In this example the user created stories can be used to fill out the background of the spy character and help the producers determine who to hire to play the spy character.

In operation the data that describes a cast member can be a stored in a data object that includes various attributes and different relationships to other data objects within the interactive system 418. For example, each cast member object can include the character's name, a user name of the user account that controls the character, gender, an image, a video, the location of the character, and other interesting aspects of the character such as whether they travel frequently, whether they have certain strengths or weaknesses, etc. In an embodiment, the administrators for the show can set certain attributes that each character may or may not have in order to establish a proper environment of the show's world, e.g., an administrator for a medical show may not allow cast members to have super powers.

The social networking engine 404 can be used to connect cast members with other cast members via groups. The characters can define roles are parts that they play within the group. Users can post open roles for the group, remove cast members from groups they control, or even remove the group. In addition, administrators of the professionally produced show can create groups that user members can join.

A specific example of a role group could be the Smith family. A male cast member can be part of the Smith family group and have the husband role. Just like in real life, the cast member object can be a member of multiple groups. Thus, Mr. Smith can also be a member of the Central Intelligence Agency group (if he or she is a spy for example) and have the analysis role, for example.

Similar to the cast member object, the information that describes the group can be described by a role group object. For example, the role group object can conform to a data model that defines group attributes such as a group type that describes the group, the roles the cast member objects have within the group, and the name of the user that controls the group. The group object can also include search metadata that describes the type of group, e.g., corporate group, family group, sports group, etc., whether the group is open to the public or is invite only, a name of the group, a scene scenario preference. Briefly, a scene scenario preference can be used to identify what types of scenes members of the group would typically be involved in so that the story engine 402 can locate the group during a search or a wizard process. In addition, group attributes and cast member object attributes can be used as search criteria when a user is searching for a character to fill a role in their story and/or find other user members to interact with.

Role groups can be used to cast members into user created stories. For example, when a user creates a scene or an episode, they will have roles that need to be filled by other cast members. The author creating the story can search for cast members that have certain roles with groups or post open auditions. For example, an author may create a story that includes a truck driver so he or she searches for a cast member that has that listed as a role they can perform. The author can then send a message to the user that controls the truck driver and ask if he or she wants to be in the story. In another example the user may post an open role for a truck driver in a forum and users can audition for the role.

In an example embodiment the content system 304 can additionally include a publishing engine 406. The publishing engine 406 can be configured to make the user created stories available to the public. Thus, the publishing engine 406 can be used to provide the overall functionality of management content created and saved from the story engine 402. In addition, the publishing engine 406 can be used to link stories to other stories, shared events, and/or global events. In an example embodiment the publishing engine 406 can also include circuitry for effectuating a screening room that allows a user to view content from the content system 400 such as user created content or professionally produced shows.

The following are a series of flowcharts depicting operational procedures. For ease of understanding, the flowcharts are organized such that the initial flowcharts present implementations via an overall “big picture” viewpoint and subsequent flowcharts provide further additions and/or details. Moreover, one of skill in the art can appreciate that the operational procedure depicted by dashed lines are considered optional. Furthermore, the following operations can be performed in a different order or simultaneously.

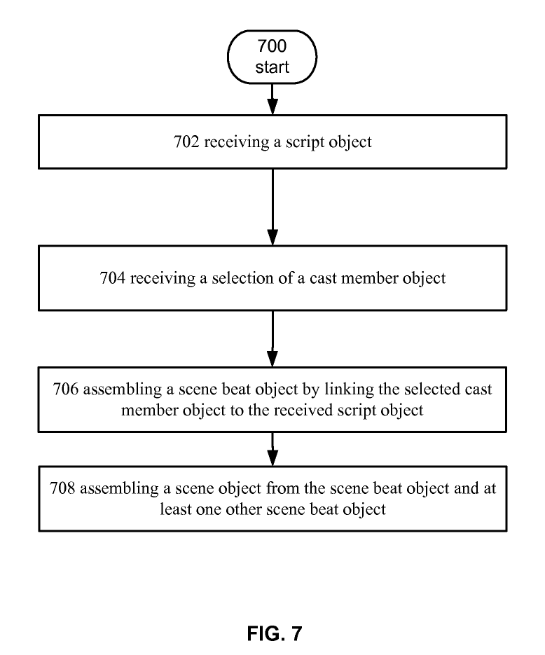

Turning to FIG. 7, it illustrates an operational procedure for practicing aspects of the present disclosure. Operation 700 begins the operational procedure and operation 702 shows receiving a script object. For example, and turning to FIG. 3, a script object 602 can be received by a network interface card of the interactive system 418. The script object 602 can include a script, e.g., text, that could have been generated from a template or could be completely original. The text, e.g., 200-500 words, could be a portion of a story and describe plot, characters, setting, or the theme of the story, a problem that creates some sort of conflict in the story, or offers some sort of resolution for an earlier presented conflict.

In an embodiment a webpage 610 or 510′ rendering a frame 600 of FIG. 6 could be displayed on a computing system such as a mobile device 403 and an author could edit the script in a script object 602. The author could select a save button displayed on the webpage and the mobile device 403 could send one or more packets of information via a network such as the Internet to an IP address associated with the web server 416. The web server 416 could in turn route the packets to the interactive system 400 which can route the information indicative of the script object 602 to the story engine 402.

Continuing with the description of FIG. 7, operation 704 shows receiving a selection of a cast member object. Turning to FIG. 3, in an embodiment a network interface card of the interactive system 418 can receive a selection of a cast member object 606. For example, the cast member object 606 can define a character that “stars” in the story being created.

A webpage 610 or 510′ could be displayed on a computing system such as a mobile device 301 that includes a frame 600 of FIG. 6 and is configured to receive a selection of a cast member object 606. The author could select a save button displayed on the webpage and the mobile device 403 could send one or more packets of information via a network such as the Internet to an IP address associated with the web server 416. The web server 416 could in turn route the packets to the interactive system 418 which can route the information indicative of the selection of a cast member object 606 to the story engine 402.

Continuing with the description of FIG. 7, operation 706 illustrates assembling a scene beat object by linking the selected cast member object to the received script object. For example, the story engine 402 can be configured to assemble a scene beat object, such as scene beat object 502, of FIG. 6 by linking an instance of the selected cast member object 606 and an instance of the script object 602 to the scene beat object 502. For example, the scene beat object 502 could have been previously generated when the author initially interfaced with the story engine 402. The scene beat object 502 can then be stored, e.g., in temporary memory and/or the database 412. In an embodiment of the present disclosure the story engine 402 can be configured to store relationships to the script object 602 and cast member object 606 in scene beat object 502. Thus, in an example embodiment content of the script object 602 and cast member object 606 may be stores in a separate file than the scene beat object 502.

Operation 708 shows assembling a scene object from the scene beat object and at least one other scene beat object. For example, and continuing with the example above, the story engine 402 can be configured to assemble a scene object such as scene object 508 of FIG. 6 by linking an instance of the scene beat object 502 to at least one other scene object such as, for example, scene beat object 504. For example, scene object 508 could have been previously generated when the author initially interfaced with the story engine 402. The scene object 508 can then be stored, e.g., in temporary memory and/or the database 412. In an embodiment of the present disclosure the story engine 402 can be configured to store relationships to scene beat object 502 and 404 in scene object 508. Thus, in an example embodiment content of the scene beat objects, and content linked to the scene beat objects may be stored separate files than the scene object 508.

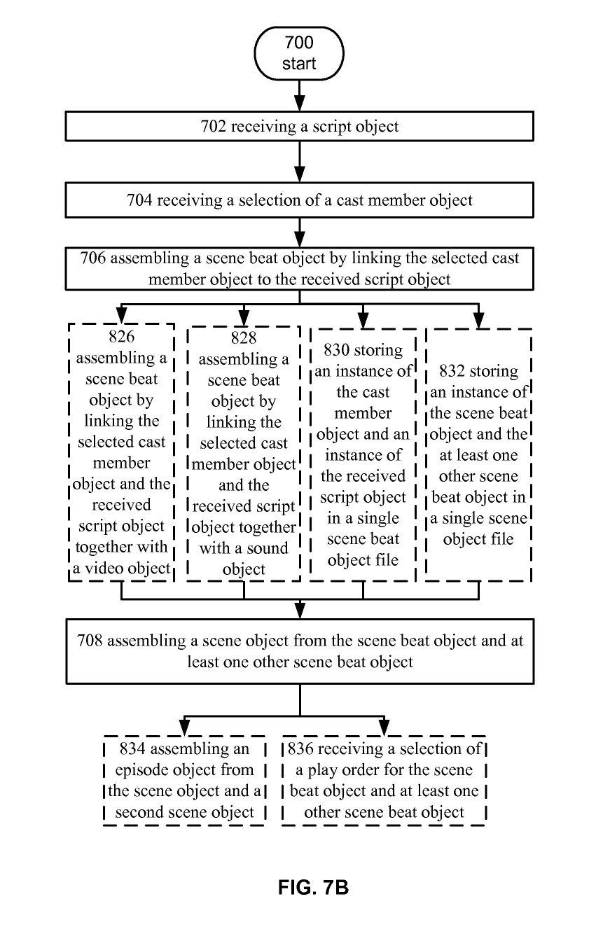

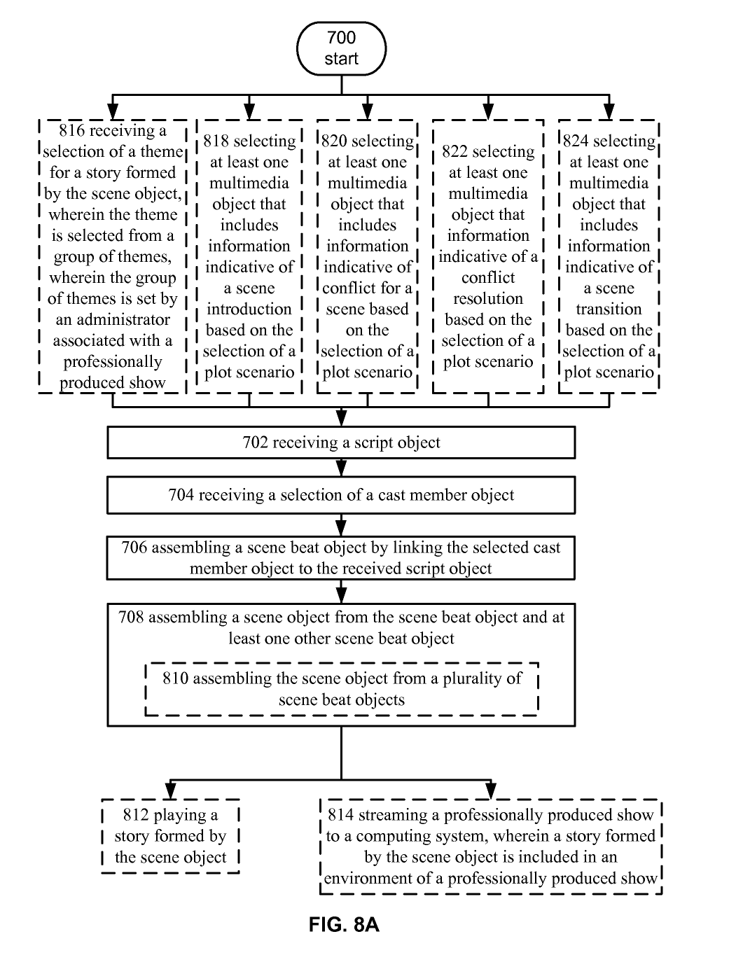

Turning now to FIG. 8A, it illustrates an alternative embodiment of the operational procedure of FIG. 7 including operations 810-824. One skilled in the art can appreciate that the operations depicted by FIG. 8A and FIG. 8B are illustrated by different figures because of page size limitations and that the disclosure is not limited by how the operations are depicted. Operation 810 illustrates assembling the scene object from a plurality of scene beat objects. For example, in an embodiment scene beat object 502 can be linked together with two other scene beat objects, e.g., scene beat objects 504 and 506 to form a scene object indicative of a story. In this example embodiment, the scene object 508 can include three beat scene objects. The first scene beat object 502 can introduce the scene, e.g., introduce the character(s) and/or the setting. The second scene beat object 504 can introduce a conflict, e.g., conflict between characters, conflict within a character, and/or conflict between an external force such as nature or the supernatural. The third scene beat object 506 can resolve the conflict or transition the scene that the beat objects form to another scene, e.g., scene object 514.

Continuing with the description of FIG. 8A, operation 812 shows playing a story formed by the scene object. For example, in an embodiment a publishing engine 406 can play, e.g., open, the assembled scene object 508 and stream the story to the IP address of a computing system such as computer system 401. In this example, a webpage may be rendered on the user interface of the computer system 401 that includes a media player that can display the streamed story. In this embodiment the publishing engine 406 may have been configured to play, e.g., execute, the individual scene beat objects 502, 504, and 506, in an order defined in the scene beat object 502 and send the resulting story, e.g., text, video, audio, etc., to the computer system 401.

In a specific example embodiment a webpage can be generated and sent to the IP address of a remote computing system such as computer system 401. The webpage can be displayed and render the story. The viewer can read the script in each scene beat and advance the story to the next scene beat until the story concludes. In an example embodiment the name of the cast member whose cast member object is assembled into the story can be displayed along with an icon for the cast member and a link to a webpage that includes the profile of the character.

In a specific example embodiment the publishing engine 406 can open scene object 508 and determine that relationships to scene beat objects are stored therein. The publishing engine 406 can obtain the scene beat objects and determine that relationships to multimedia objects are stored therein. The publishing engine 406 can obtain the multimedia objects, build a story from the multimedia objects and information in the scene beat and scene objects, and send stream packets indicative of the multimedia objects to the computing system.

In a specific example where the scene object includes scene beat objects (and associated or included multimedia content) as described in more detail below, the publishing engine 406 can open the scene object 508 and build a story from the multimedia objects and information stored therein and stream packets indicative of the multimedia objects to the computing system.

Operation 814 of FIG. 8A shows streaming a professionally produced show to a computing system, wherein a story formed by the scene object is included in an environment of a professionally produced show. For example, in an embodiment a network adaptor of a web server 416 can be configured to stream a professionally produced show to the IP address associated with a computing system such as computer system 401. In this example the story that is created by playing the scene object 508 can exist in the environment created by a production company that produces a show. That is, the story can be part of the fictionalized world created by the producers of the professionally produced show. In a specific example, the show could be The Simpsons® and the story created from the scene object could exist within The Simpsons' universe, e.g., the scene could be set in Springfield or even at the nuclear power plant where Homer Simpson works.

Continuing with the description of FIG. 8A, operation 816 shows receiving a selection of a theme for a story formed by the scene object, wherein the theme is selected from a group of themes, wherein the group of themes is set by an administrator associated with a professionally produced show. For example, in an embodiment a network adaptor of the interactive system 418 can receive one of more packets indicative of a selection of a theme, e.g., the subject matter of the scene object, for the story that is created from the scene object 402. In this example, the computing system 401 can display a list of themes that have been set by an administrator that is associated with the professionally produced show and the author can select one. For example, the show may fall into a style such as action, drama, comedy, suspense, or romance and the production company may want to restrict the subject matter that an author can create stories about in order to keep the context for the shows consistent. Or put another way, people that are interested in the show may be confused if certain dramatic story elements are not present in user created stories. For example, a producer of a romantic style show may not want users to create action themed stories in the show's environment because the audience is expecting romantic type user created stories. In another example, the production company may use the theme to tailor what type of multimedia content and scene scenarios is returned in a search result.

Turning now to operation 818 it shows selecting at least one multimedia object that includes information indicative of a scene introduction based on the selection of a plot scenario. For example, in an embodiment of the present disclosure a network adaptor of the interactive system 418 can receive one or more packets of information indicative of a selection of a scene scenario and the story engine 402 can be configured to select at least one multimedia object, e.g., a script template, that includes pre-generated text that describes a scene introduction. That is, the story engine 402 can be configured to select at last one multimedia object that has the purpose of informing the readers about the plot, character(s), and/or setting, of the story. In writing there are different techniques used for presenting information such as narration, description, exposition, and the like. Content producers associated with the professionally produced show can create script templates using these literary techniques and create them in a way so that they broadly convey information and have blanks for the users to fill in the details. Each multimedia object can be tagged with metadata that identifies the type of plot the object is associated with and what story element it is associated with, e.g., introduction, and stored in the database 412.

In a specific example, multimedia objects can be organized according to scene scenario and plot scenario. If a plot scenario is thought of as a story outline, then the scene scenario can be thought of as an outline for a scene within that story. In this example the story engine 402 can be first configured to search for plot scenarios and the author can select one. The story engine 402 can then search for scene scenarios for the individual scenes and the author can select one for each scene in their story. The story engine 402 can execute a query on the database 412 and obtain different multimedia objects to populate the different scenes based on the selection of the plot of the story and the plot for each scene. In this example the story engine 402 can be configured to select at least some introductory type scene scenarios.

Turning now to operation 820 it shows selecting at least one multimedia object that includes information indicative of conflict for a scene based on the selection of a plot scenario. For example, in an embodiment of the present disclosure a network adaptor of the interactive system 418 can receive one or more packets of information indicative of a selection of a scene scenario and the story engine 402 can be configured to select at least one multimedia object, e.g., a video object, illustrates some sort of conflict, e.g., car chase, fight scene, argument with spouse, etc., for the scene. That is, the story engine 402 can be configured to select at least one multimedia object that has the purpose setting up some sort of problem in the scene that a character has to solve. For example, the conflict could be character vs. himself, character vs. society, character vs. nature, character vs. some other character, etc. Content producers associated with the professionally produced show can create video objects that setup different types of conflict and associate them with templates that include blanks for the authors to fill in the details of who is in the conflict. Each multimedia object can be tagged with metadata that identifies the type of plot the object is associated with and what story element it is associated with, e.g., conflict in this example, and stored in the database 412.

Turning now to operation 822 it shows selecting at least one multimedia object that information indicative of a conflict resolution based on the selection of a plot scenario. For example, in an embodiment of the present disclosure a network adaptor of the interactive system 418 can receive one or more packets of information indicative of a selection of a scene scenario and the story engine 402 can be configured to select at least one multimedia object, e.g., a video object, that includes pre-generated text that describes a way to resolve conflict. That is, the story engine 402 can be configured to select at least one multimedia object that has the purpose of resolving some sort of problem in the scene that involves the character. Content producers associated with the professionally produced show can create script templates that resolve unnamed conflicts between two entities and leave blanks in the templates for the authors to fill in the details. Each multimedia object can be tagged with metadata that identifies the type of plot the object is associated with stored in the database 412.

Turning now to operation 824 it shows selecting at least one multimedia object that includes information indicative of a scene transition based on the selection of a plot scenario. For example, in an embodiment of the present disclosure a network adaptor of the interactive system 418 can receive one or more packets of information indicative of a selection of a scene scenario and the story engine 402 can be configured to select at least one multimedia object, e.g., a script template, that includes pre-generated text that describes a way to transition the scene to the next one. That is, the story engine 402 can be configured to select at least one multimedia object that has the purpose of signaling a change in the story, e.g., change in time, location, point-of-view, character, mode, pace, etc. Content producers associated with the professionally produced show can create script templates that use words, phrases, paragraphs, and/or punctuation to signal transition between the current scene to a next scene. In this example characters, current time, location, etc., can be blanks so the author can fill in the details. Each multimedia object can be tagged with metadata that identifies the type of plot the object is associated with, and stored in the database 412.

Turning to FIG. 8B, it illustrates an alternative embodiment of the operational procedure of FIG. 7. Turning to operation 826 illustrates assembling a scene beat object by linking the selected cast member object and the received script object together with a video object. For example, in an embodiment the story engine 402 can be configured to assemble a scene beat object from a cast member object, the received script object, and a video object. In a specific example, the story engine 402 can store relationships between the cast member object 606, the received script object 602, and a video object 604 in a scene beat object 502.

In a specific example, and turning to FIG. 6, a webpage 610 or 610′ can be displayed on computer system 401 that includes frame 600. In this example an author could use controls 612 to specify how many scenes will be in the story, how many beats will exist per scene, etc. The author can open a scene beat object 502 for example, and select a video object 604 and/or an audio object 608. The selection can open up a search box where the author can search database 412 for video objects and/or open up a box where the author can upload video stored on the computer system 401. The author can then select a video object 604 they think fits the scene beat object 502 the most. The author can close the scene beat object 502 and the story engine 402 can receive one or more packets indicative of the current contents of the scene beat object 502 and store a scene beat object 502 in database 412 that includes a relationship between the cast member object 606, the received script object 602, and a video object 604.

Continuing with the description of FIG. 8, operation 828 shows assembling a scene beat object by linking the selected cast member object and the received script object together with a sound object. For example, in an embodiment the story engine 402 can be configured to assemble a scene beat object from a cast member object 606, the received script object 602, and a sound object 608. In a specific example, the story engine 402 can store relationships between the cast member object 606, the received script object 602, and a sound object 608 in a scene beat object 502.

In a specific example, and turning to FIG. 6, a webpage 610 or 610′ can be displayed on a computing system, e.g., computer system 401, for example, that includes frame 600. In this example an author could use controls 612 to specify how many scenes will be in the story, which cast members are cast in a scene beat object, how many beats per scene, etc. The author can open a scene beat object 502 for example, and select video object 604 and/or an audio object 604. The selection can open up a search box where the author can search database 412 for audio objects and/or specify that they wish to upload an audio object from their computing system. The author can then select an audio object they think fits the scene beat object 502 the most. The author can close the scene beat object 502 and the story engine 402 can receive one or more packets indicative of the current contents of the scene beat object 502 and store relationships between the cast member object 606, the received script object 602, and the selected audio object 608 in the scene beat object 502.

Turning back to FIG. 8B, operation 830 illustrates storing an instance of the cast member object and an instance of the received script object in a single scene beat object file. For example, in an embodiment of the present disclosure instances of multimedia objects assembled into a scene beat object 502 can be stored in a single file in the database 412. For example, the file that stores the scene beat object 502 can be configured to include multimedia objects.

Operation 832 illustrates storing an instance of the scene beat object and the at least one other scene beat object in a single scene object file. For example, in an embodiment of the present disclosure the scene object 508 can include scene beat objects (and the multimedia objects associated or stored in the scene beat objects).

Operation 834 illustrates assembling an episode object from the scene object and a second scene object. For example, in an embodiment the story engine 402 can be configured to assemble an episode object 524 from the scene object 508 and a second scene object such as, scene object 514. For example, when the author receives a copy of webpage 610 or 610′ he or she can use controls 612 to select that the story will be told in an episode, number of scenes, and number of beats per each scene. In this example the story engine 402 can generate an episode object 524 and objects for the number scenes and number of beats per scene. The episode object 524 can include a relationship between the two scene objects or the episode object 524 can include the two scene objects.

Continuing with the description of FIG. 8B, operation 836 illustrates receiving a selection of a play order for the scene beat object and at least one other scene beat object. For example, each scene beat object is a data object that tells a portion of a story when played. In this example the story engine 402 can be configured to rearrange the order of the scene beat objects thereby changing the order in which the publishing engine 406 plays the story. In a specific example the play order can be stored in a scene object 508. In this example the scene object 508 can include the scene beat object 502, or relationships to the scene beat objects, and information that defines the order in which they are played by the publishing engine 406. In another example the story engine 402 can use a linked list to maintain the ordering of the objects without storing the order in a scene object. For example, each scene beat object can be part of a linked list. Each scene beat object can contain a reference number that links the scene beat object to the next scene beat object in the list. The scene beat object at the end of the list can contain a reference to a null number. The publishing engine 406 can be configured to start playing the scene beat object at the end of the list and continue to play the objects until the null reference number is reached. Similarly, the episode object 524 can also include information that defines a play order for a scene objects it is associated with or the scene objects can be part of a linked list.

Turning to FIG. 6, the author can select the play order, e.g., by dragging and dropping the objects displayed in frame 600 into the desired order, and select a save button in controls 612. For example, the author may want to place scene object 514 before scene object 508. In this example the author could rearrange the ordering using controls 612 and/or dragging and dropping scene object 508 above scene object 508. The computing system used by the author can send one or more packets indicative of the play order to the web server 416. The web server 416 can route the packets to the story engine 402 which can update the play order for the scene objects by changing the play order in an episode object 524 for example.

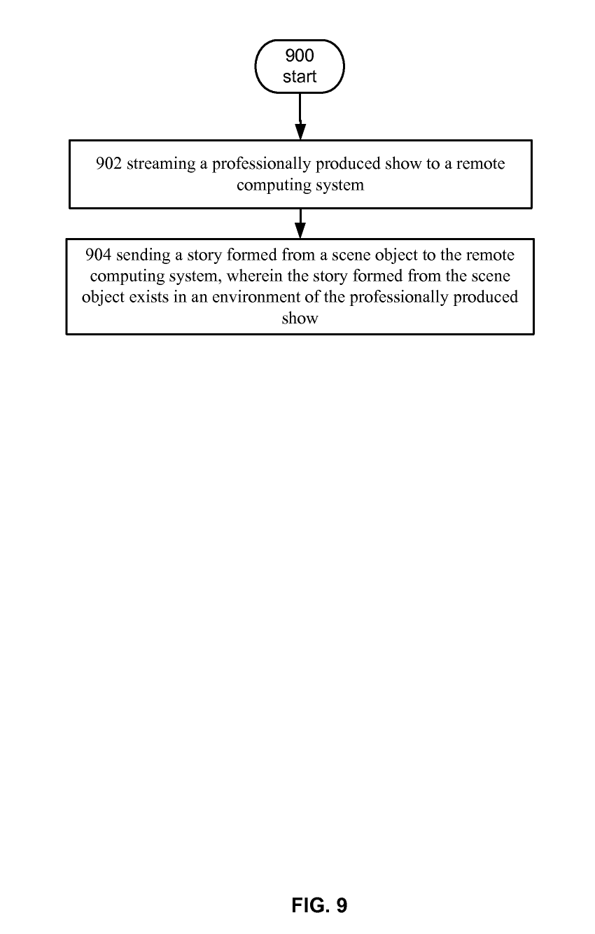

Turning now to FIG. 9, it depicts an operational procedure for practicing aspects of the present disclosure including operations 900, 902, and 904. Operation 900 begins the operational procedure and operation 902 illustrates streaming a professionally produced show to a remote computing system. For example, and turning to FIG. 3, a professionally produced show, e.g., a show developed by professional writers and including paid professional actors, can be streamed to a remote computing system such as a mobile device 403 by distribution network 414. For example, a user can use a web browser of a computing system to navigate to the IP address of the web server 416, search through the various shows and select one to view. In response, the web server 416 can fetch a copy of the show and start streaming it to the IP address of the computing system. The web browser of the computing system can include a player module, e.g., browser plugin that plays videos that conform to a certain protocol.

Continuing with the description of FIG. 9, operation 904 shows sending a story formed from a scene object to the remote computing system, wherein the story formed from the scene object exists in an environment of the professionally produced show. For example, and in addition to the previous example, web server 416 can be configured to send a data stream indicative of a story to the remote computing system, e.g., mobile device 403, that is formed from a scene object. For example, a user can use a web browser of a computing system to navigate to the IP address of the web server 416 and be routed to the publishing engine 406. The user can search through the stories and decide to play a particular one. In response to the selection, the publishing engine 406, via the web server 416, can send one or more packets indicative of the story to the IP address of the computing system. In this example the story can be set in the world that includes the professionally produced show. For example, the professionally produced show, e.g., Law and Order®, a legal drama television show, is be set in a fictional world, e.g., one where a fictionalize New York City Police Department and fictionalized New York City District Attorney's Office exist. In this example the story formed from the scene object 508 can be set in the same world as the professionally produced show thus expanding the show's world.

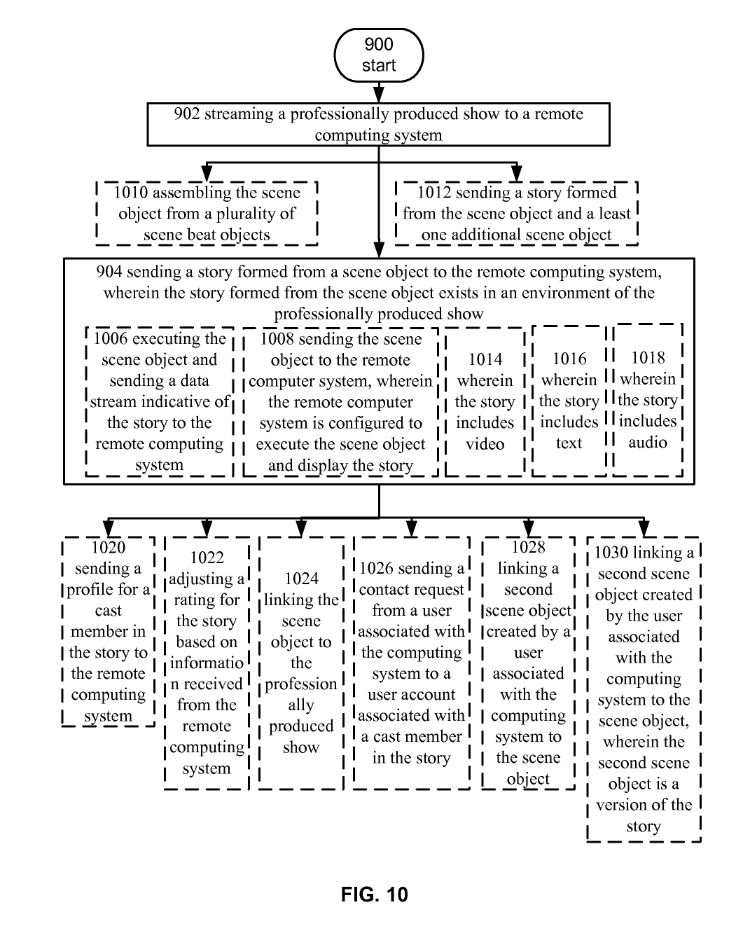

Turning now to FIG. 10, it illustrates an alternative embodiment of the operational procedure of FIG. 9 including additional operations 1006-1028. Operation 1006 shows executing the scene object and sending a data stream indicative of the story to the remote computing system. For example, in an embodiment the publishing engine 406 can be configured to execute the scene object 508 and generate a data stream indicative of the story. The publishing engine 406 can be configured to send the data stream to the web server 416 which can send it to the IP address associated with the remote computing system, e.g., the mobile device 403. In a specific example, instances of multimedia objects assembled into a scene beat object 502 can be stored in a single file in the database 412 and the scene object 402 can include an instance of the scene beat object 502. In this example the publishing engine 406 can open the scene object 508 and build a story from the multimedia objects and information stored therein and stream packets indicative of the multimedia objects to the computing system.

Continuing with the description of FIG. 10, operation 1008 shows sending the scene object to the remote computer system, wherein the remote computer system is configured to execute the scene object and display the story. For example, in an embodiment the publishing engine 406 can be configured to send the scene object 508 to the web server 416 which can send it to the IP address associated with the remote computing system. In an example embodiment where the scene object 508 includes links to scene beat objects (502-506), the publishing engine 406 can be configured to compile the various scene beat objects (including multimedia content) into the scene object 508 and send it to the remote computer system. In another example, instead of compiling the scene beat objects into a single scene object, the publishing engine 406 can send the individual scene beat objects (402-406) to the client and the client player can link the story together at runtime from information in the scene beat objects (502-506). In this example the mobile device 403 can include a player that can execute the scene object 508, generate a data stream indicative of the story, and display the story on a display.

Continuing with the description of FIG. 10, operation 1010 shows assembling the scene object from a plurality of scene beat objects. For example, in an embodiment the interactive system 418 can include a story engine 402 that can be configured to assemble scene objects from scene beat objects. Turning to FIG. 5, the story engine 402 can generate a webpage (either 610 or 610′) that includes functionality to build a scene object 508. In an example embodiment an author can select multimedia objects to place within scene beat objects, e.g., scene beat object 502 and 404 and save the results. The story engine 402 can assemble, e.g., compile the scene beat objects into a single scene file, or generate relationships between the scene beat objects stored in separate files.

Turning to operation 1012, it illustrates sending a story formed from the scene object and a least one additional scene object. For example, in an embodiment a story can be formed from multiple scene objects, e.g., multiple scene objects in an episode or in a series. In this example embodiment the publishing engine 406 can be configured to execute scene object 502 and at least one other scene object, generate a data stream indicative of the story, and send it to the mobile device 403.

In another embodiment, the publishing engine 406 can send the multiple scene objects and scene beat objects to the client computing system. The publishing engine 406 can be configured to send the multiple scene objects to the web server 416 which can send them to the IP address associated with computing system. The client player can link the story together at runtime from information in the scene objects and scene beat objects and play the story.

In another example embodiment the scene objects and scene beat objects can be stored as separate files with relationships to each other. In this example the publishing engine 406 can be configured to execute the objects at runtime from information in the scene objects and scene beat objects to generate a data stream indicative of the story. The publishing engine 406 can be configured to send the data stream to the web server 416 which can send it to the IP address associated with the remote computing system.

Turning to operation 1014, it illustrates an example embodiment where the story includes video. For example, the story that can be displayed on the screen of the computing system can include a video clip, e.g., 30 seconds worth of video for example. In this example the video could have been uploaded by the creator of the story, or it could have been created by content producers associated with the professionally produced show.

Turning to operation 1016, it illustrates an example embodiment where the story includes text. For example, in an embodiment the story can include text, e.g., dialog or narration, that advances the story. In this example the text could be created solely by the author of the story or it could have been based on a template created by content producers associated with the professionally produced show.

Continuing with the description of FIG. 10, operation 1018 shows an example embodiment where the story includes audio. For example, the story that can be displayed on the screen of the computing system can include an audio clip, e.g., one minute worth of audio for example. In this example the audio could be sound effects, music, dialog, etc. The audio could have been uploaded by the creator of the story, or it could have been created by content producers associated with the professionally produced show.

Continuing with the description of FIG. 10, operation 1020 shows sending a profile for a cast member in the story to the remote computing system. For example, in an embodiment the story can include a character that is described in a cast member object stored in database 412. As stated above, in an embodiment a character in the story can have a profile in a social networking website that can describe who the cast member is and what relationships they have to other cast members or groups. For example, each cast member object can include the character's name, a user name of the user account that controls the character, gender, an image, a video, the location of the character, and other interesting aspects of the character such as whether they travel frequently, whether they have certain strengths or weaknesses, etc.

In this example the publishing engine 406 can be configured to send a webpage that includes information describing the cast member to the remote computing system. For example, a user viewing the story may be interested in one of the characters in the story and want to learn more about him or her. In this example the webpage including the story can be configured to include links to the profile of the character in the story. The user can select the link and the computing system can send one or more packets of information to the web server 416. The web server 416 can route the request to the social networking engine 404 which can be configured to send a copy of the profile webpage for the character to the remote computing system.

Continuing with the description of FIG. 9, operation 1022 shows adjusting a rating for the story based on information received from the remote computing system. For example, in an embodiment social networking engine 404 can be configured to adjust, e.g., raise or lower, a user rating for the story formed from the scene object 402 based on input received from the remote computing system. For example the viewer can provide feedback about the story. For example, the webpage displaying the story can include logic to allow a user to provide feedback such as 1 to 5 stars, 1 out of 10 rating, and/or a critique. The information can be sent from the computing system to the web server 416 and routed to the social networking engine 404. The social networking engine 404 can adjust the rating of the story and generate lists of stories such as, for example, top 10 stories of the week, top stories of all time, etc.

In an example the producers of the professionally produced show may use the ratings to add secondary characters to the main story. For example, if the producers need to add another character to the cast, and/or need a character for a scene the producers can draw from the pool of user created characters that exist in the show's world. The producers can see which characters and stories are highly rated and decide to use the character profile and stories to create a background for the character being added to the main story.

Continuing with the description of FIG. 10, operation 1024 shows linking the scene object to the professionally produced show. For example, in an embodiment when the scene object is assembled it can be linked to the professionally produced show so that a viewer of the show can locate it in a search. For example, the publishing engine 406 can create a relationship between the scene object and a data object that represents the show in the content system 400. In this example, if a viewer of the show is interested in what the user members have created in the show's environment he or she can submit a query to the web server 416 for user created content. The publishing engine 406 can receive the request and search database 412 for user content that is linked to the show. The publishing engine 406 can then send the search results to the web server 416 which can send a webpage to the IP address of the computing system that includes the search results.

Continuing with the description of FIG. 10, operation 1026 shows sending a contact request from a user associated with the computing system to a user account associated with a cast member in the story. For example, in an embodiment the social networking engine 404 can be configured to send a “friend” request to a user account associated with a cast member in the story. The social networking engine 404 can be configured to allow members to maintain a contact list, e.g., a collection of screen names in the content system 400 that represent either user members or fictional character.

Continuing with the description of FIG. 10, operation 1028 shows linking a second scene object created by a user associated with the computing system to the scene object. For example, in an embodiment the publishing engine 406 can be configured to create a relationship between the scene object 402 and a second scene object that was created by a user of the computing system, e.g., the viewer. That is, scene object 402 and the scene object created by the user of the computing system may have different authors in an embodiment. In this example a linked story can indicate that the second scene object is somehow related to the first scene object. For example, the relationship could be based on the characters in the story, the setting of the story, etc. In a specific example the story could have been set at an event like a concert and could have described a date between two characters. The second scene object could be a story that takes place during the same concert and be about a person that lost their ticket and couldn't get into the concert. In this example the stories are related to a common event and the publishing engine 406 can be configured to create relationships between the two stories.

Continuing with the description of FIG. 10, operation 1030 shows linking a second scene object created by the user associated with the computing system to the scene object, wherein the second scene object is a version of the story. For example, in an operation that is similar to operation 924, the publishing engine 406 can be configured to create a relationship between the scene object and a second scene object that was created by a user of the computing system, e.g., the viewer. That is, scene object 402 and the scene object created by the user of the computing system may have different authors in an embodiment. In this example a linked story can indicate that the second scene object is related to the first in that it describes a common scene from a different character's perspective. For example, in an embodiment the story could have included a character owned by the user of the computing system. In this example a user may have made a story and cast the user of the computing system's fictional character to play a role in the story. The user of the computing system could view how their character was used in the story and decide to create their version of the scene in which their character was cast. In this example the stories are related to a common event and the publishing engine 406 can be configured to create relationships between the two stories.

In a specific example, a first user may create a story about a couple on a date and cast a second user's character as a police office that helped the couple on the date avoids being mugged. The second user can then create his or her version of the scene in which their character (the police officer) helped the couple. For example, the second user could flesh out how the police officer knew to be in the right place at the right time to prevent the mugging and what happened to the police officer next.

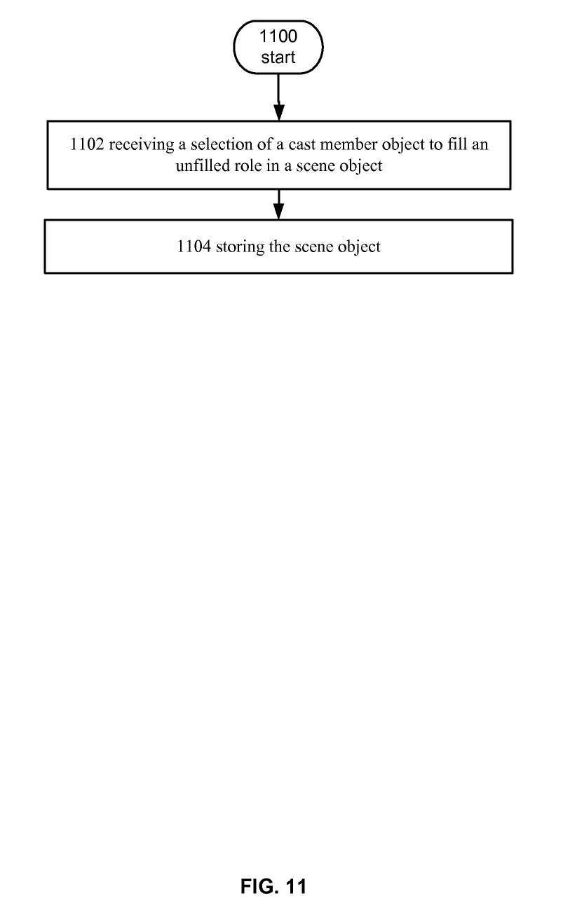

Turning now to FIG. 11, it illustrates an operational procedure for practicing aspects of the present disclosure including operations 1100, 1102, and 1104. Operation 1100 begins the operational procedure and operation 1102 shows receiving a selection of a cast member object to fill an unfilled role in a scene object. For example, in an embodiment a webpage can be displayed on a computing system of an author that includes a frame 600 and the author of the computing system can use the frame 600 to create a scene object 508. In an example embodiment the scene object 508 can encapsulate an entire story, e.g., a single scene story, or it can encapsulate a portion of a story, e.g., a story that spans multiple scenes or episodes. In this example the author can determine that they would like to add roles to the story that are filled by user created characters and add a character that is encapsulated in a cast member object 606. The author can select a cast member object 606 and use save logic in controls 612 to save the scene object 508. In this example the story engine 402 can receive a signal indicating the cast member object identifier that was added to the scene object 508.

Continuing with the description of FIG. 11, operation 1104 shows storing the scene object. For example, in an embodiment a story engine 402 can be configured to store a scene object 508 it in a database 412. As shown by FIG. 6, in an embodiment the story can be made from scene objects 508, 514, 522, which can in turn be made from scene beat objects 502-506. The user can add multimedia content to scene beat objects and save them. When the author uses the save logic in controls 612 the computing system can send one or more packets of information to the web server 416. The web server 416 can route the information to the story engine 402 which can generate, e.g., create, a scene object 508 that, for example, includes information in the scene beat objects 402, 404, and 406, such as play order and the assembled multimedia content.

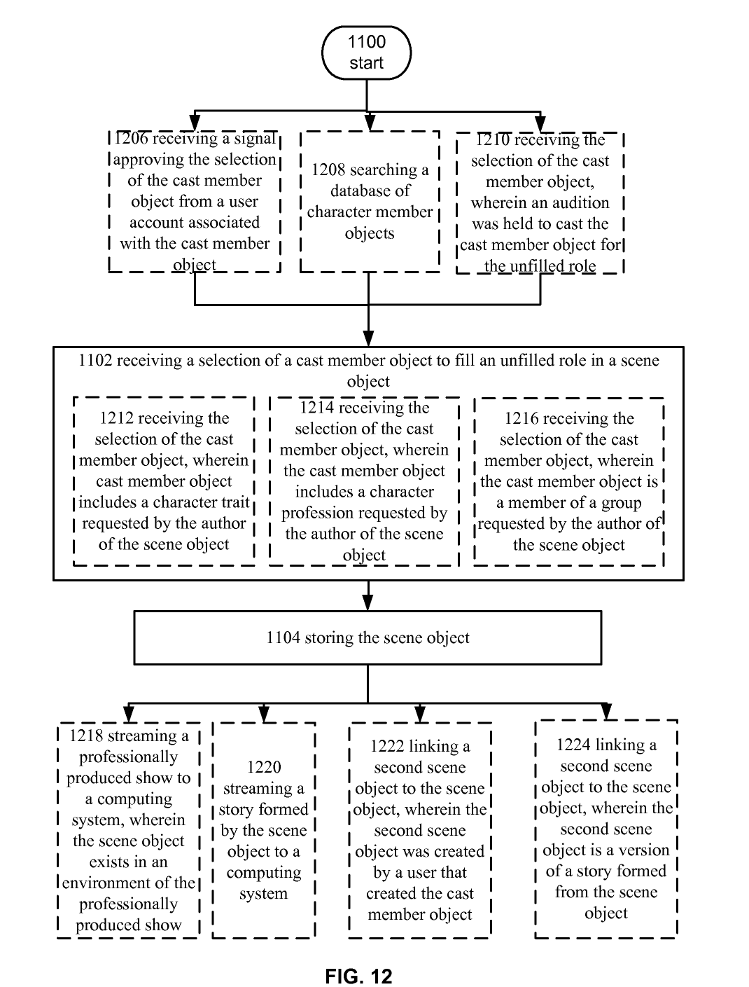

Turning now to FIG. 12, it illustrates an alternative embodiment of the operational procedure of FIG. 11 including operations 1206-1224. Operation 1206 shows receiving a signal approving the selection of the cast member object from a user account associated with the cast member object. For example, in an embodiment the social networking engine 404 can be configured to receive a signal indicating that the cast member object 606 can be used in scene object 508. For example, the cast member object 606 may be controlled by a different user than the user creating the story object and permission to use the character must be obtained, e.g., the owner of the character may set profile settings to require authorization before the character can be cast. In this example when the author selects the cast member object 606 an email requesting approval can be sent to the user account of the user that controls the character. If the user wants to allow the character to be in the story he or she can select an approve command and a signal can be sent to the story engine 402 indicating that the cast member object 606 can be used. In an example embodiment when cast member object 606 requests are pending the story engine 402 can save the scene object and indicate that the request to use the cast member object is pending. In this example the story engine 402 can be configured to prevent the author from publishing the scene while a character request is pending.

Continuing with the description of FIG. 12, operation 1208 shows searching a database of character member objects. For example, the author can search a database 412 of cast member objects and select cast member object 606 to fill the role in the scene object 508. For example, and referring to FIG. 6, the author could decide to add a cast member object 606 to the scene object 508 and use controls 612 to add a role from a drop down menu. The author can select logic to add a character to the unfilled character role and a signal can be sent to the social networking engine 404. The social networking engine 404 can search the database 412 for characters according to a search query and return a webpage including the results to the computing system. The author can scroll through the cast member profiles and select one.

Continuing with the description of FIG. 12, operation 1210 shows receiving the selection of the cast member object, wherein an audition was held to cast the cast member object for the unfilled role. For example, in an embodiment an author can decide to hold auditions for the unfilled role. In this example and referring to FIG. 6, the author could decide to add a cast member object 606 to the scene and use controls 612 to add a character role from a drop down menu. The author can select logic to add a character to the unfilled role and select that they want to accept auditions for the role and a signal indicative of the request can be sent to the social networking engine 404. The social networking engine 404 can receive the request and post an audition for the role on a forum. In this example the social networking engine 404 can post information such as the plot of the scene object, the user name of the user creating the story, and/or any information a user deciding whether to audition would think relevant. In this example the author creating the scene object 508 can receive a list of interested users and determine which one to cast.

Continuing with the description of FIG. 12, operation 1212 shows receiving the selection of the cast member object, wherein cast member object includes a character trait requested by the author of the scene object. For example, in an embodiment an author can decide to add a cast member object 606 to the scene object 508 and use controls 612 to add a character role from a drop down menu. In this example the author could search the database 412 for characters including the desired trait or hold an audition and specify that they want characters that have the desired trait, e.g., tall, short, speaks French, has a certain skill, etc. If the author performs a search, the social networking engine 404 can search the database 412 for characters that include the trait and return a webpage including the results to the computing system. The author can scroll through the cast member profiles and select one. In the instance that the author holds an audition, the social networking engine 404 can receive the request and post an audition for the role on a forum that indicates that the role requires a certain character trait. In this example the social networking engine 404 can also post information such as the plot of the story, the user name of the author, and/or any information a user deciding whether to audition would think relevant. In this example the author creating the scene object 508 can receive a list of interested users and determine which one to cast.

Continuing with the description of FIG. 12, operation 1214 shows receiving the selection of the cast member object, wherein the cast member object includes a character profession requested by the author of the scene object. For example, an author can decide to add a cast member object 606 to the scene object 508 and use controls 612 to add a character role from a drop down menu. In this example the author could search database 412 for characters including the desired profession, e.g., spy, accountant, patent lawyer, or hold an audition and specify that they want characters that include the desired profession. If the author performs a search, the social networking engine 404 can search database 412 for characters that include the profession and return a webpage including the results to the computing system. The author can scroll through the cast member profiles and select one. In the instance that the author holds an audition, the social networking engine 404 can receive the request and post an audition for the role on a forum that indicates that the role requires a certain character profession. In this example the social networking engine 404 can also post information such as the plot of the story, the user name of the author creating the story, and/or any information a user deciding whether to audition would think relevant. In this example the author creating the scene object 508 can receive a list of interested users and determine which one to cast.

Continuing with the description of FIG. 12, operation 1216 shows receiving the selection of the cast member object, wherein the cast member object is a member of a group requested by the author of the scene object. For example, an author can decide to add a cast member object 606 to the scene and use controls 612 to add a character role from a drop down menu. In this example the author could search the database 412 for characters that are members of a group, e.g., Smith family group, Law firm group, baseball team group, or hold an audition and specify that they want characters that are members of a certain group. If the author performs a search, the social networking engine 404 can search database 412 for characters that are members of the group and return a webpage including the results to the computing system. The author can scroll through the cast member profiles and select one. In the instance that the author holds an audition, the social networking engine 404 can receive the request and post an audition for the role on a forum that indicates that the role requires membership in a certain group. In this example the social networking engine 404 can also post information such as the plot of the scene object, the user name of the author creating the story, and/or any information a user deciding whether to audition would think relevant. In this example the author creating the scene object 508 can receive a list of interested users and determine which one to cast.

Continuing with the description of FIG. 12, operation 1218 shows streaming a professionally produced show to a computing system, wherein the scene object exists in an environment of the professionally produced show. For example, web server 416 can be configured to stream a professionally produced show to a computing system such as a computer system 401. In this example the scene object 508 can tell a story that is set in the world that includes the professionally produced show. For example, the professionally produced show, e.g., Battlestar Galactica® the 2004 TV series, is set on a space ship in a distant part of the galaxy. In this example the story told by the scene object 508 can be set in the same world as the professionally produced show thus expanding the world. In this specific example, the story told by the scene object 508 could be set on the Battlestar Galactica® and tell a story about two members of her crew.

Continuing with the description of FIG. 12, operation 1220 shows streaming a story formed by the scene object to a computing system. For example, web server 416 can be configured to stream a story that is formed from a scene object 508 to the remote computing system. For example, a user can use a web browser of a computing system to navigate to the IP address of the web server 416 and be routed to the publishing engine 406. The user can search through the stories and decide to play a particular one. In response to the selection, the publishing engine 406, via the web server 416, can send one or more packets indicative of the story to the IP address of the computing system.

Continuing with the description of FIG. 12, operation 1222 shows linking a second scene object to the scene object, wherein the second scene object was created by a user that created the cast member object. For example, in an embodiment the publishing engine 406 can be configured to create a relationship between the scene object 508 and a second scene object that was created by a user that created the cast member object 606. In this example a linked story can indicate that the second scene object is somehow related to the first scene object. For example, the relationship could be based on the characters in the story, the setting of the story, etc. In a specific example the story could have been set at a shared event like a concert and could have described a date between someone and the character described by the cast member object 606. The second scene object could be a story that takes place during, before, or right afterward the same concert and be about the character described by the cast member object 606.

Continuing with the description of FIG. 12, operation 1224 shows linking a second scene object to the scene object, wherein the second scene object is a version of a story formed from the scene object. For example, the publishing engine 406 can be configured to create a relationship between the scene object and a second scene object that was created by a user of the computing system, e.g., a viewer. In this example a linked story can indicate that the second scene object is related to the first because it describes a shared event from different character's viewpoints. For example, in an embodiment the story could have included a character owned by the user of the computing system. In this example an author may have made a story and cast the user of the computing system's fictional character to play a role in the story. The user of the computing system could view how there character was used in the story and decide to create their version of the scene that their character was cast. In this example the stories are related to a common event in that they are about the same event but told from different perspectives and the publishing engine 406 can be configured to create relationships between the two stories.

In a specific example, a first user may create a story about a spy that is collecting information about a foreign government and cast a second user's character as a get-away-driver hired for a job that involves breaking into the a foreign government building. The second user can then create his or her version of the scene where the get-away-driver is waiting outside for the spy to finish in the building. For example, the second user could flesh out why he or she took the job, or how he had to subdue a security guard that saw the parked get-away-car.

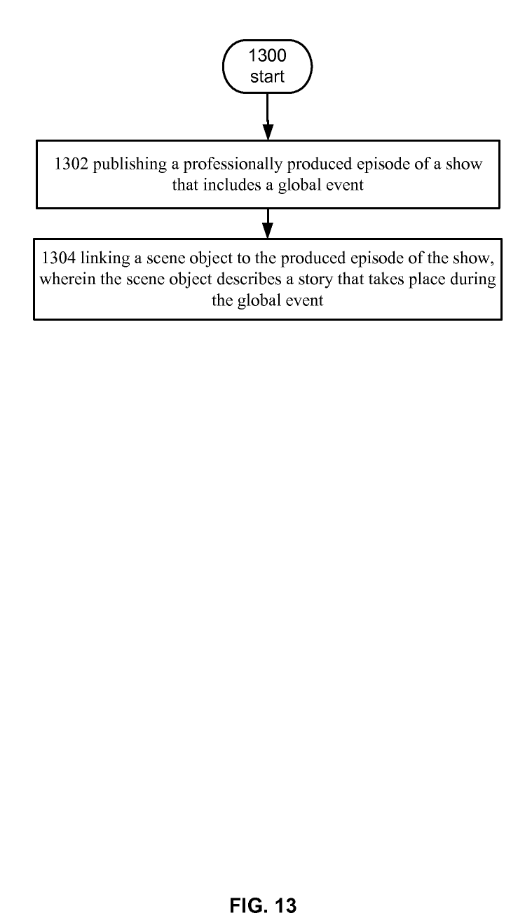

Turning now to FIG. 13, it illustrates an operational procedure for practicing aspects of the present disclosure including operations 1300, 1302, and 1304. Turning to operation 1300, it begins the procedure and operation 1302 shows publishing a professionally produced episode of a show that includes a global event. For example, in an embodiment a distribution network 414 can publish a show that was produced by a professional production company, e.g., written by professional writers and includes professional actors. In this example an episode of the show can include a global event. For example, a global event can be an event that can affect nearly everyone in the show's environment in some way, even if they were not present at the event itself. An example of a global event would be the day when President Obama took office or when the United States landed a man on the moon. In this example embodiment an administrator associated with the show could create a global event object that represents the global event and store it in the database 412. For example, the global event object could have a title, description, and links to clips in the episode showing how the global event was treated in the show, etc. The social networking engine 404 can process the global event object and post a global event to a forum or list it on a webpage that users see when they connect to the content system 400.

Continuing with the description of FIG. 13, operation 1304 shows linking a scene object to the produced episode of the show, wherein the scene object describes a story that takes place during the global event. For example, users can see that a global event has been posted and create their own scene objects that tell stories that take place during global event. In an example embodiment the scene object 508 can be assembled by the story engine 402 from scene beat objects including multimedia objects. Once the user is happy with the story, the story engine 402 can assemble, e.g., compile the contents of the scene beat objects into a single scene file or generate relationships between the scene beat objects stored in separate files. In this example embodiment content producers associated with the professionally produced show can create multimedia content customized for the global event.

The foregoing detailed description has set forth various embodiments of the systems and/or processes via examples and/or operational diagrams. Insofar as such block diagrams, and/or examples contain one or more functions and/or operations, it will be understood by those within the art that each function and/or operation within such block diagrams, or examples can be implemented, individually and/or collectively, by a wide range of hardware, software, firmware, or virtually any combination thereof.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

What is claimed is:

1. A computer readable storage medium for generating a scene object, comprising:
instructions for receiving a script object;
instructions for receiving a selection of a cast member object; and
instructions for assembling a scene beat object by linking the selected cast member object to the received script object; and
instructions for assembling a scene object from the scene beat object and at least one other scene beat object.

2. The computer readable storage medium of claim 1, wherein the instructions for assembling the scene object from the scene beat object and at least one other scene beat object further comprise:
instructions for assembling the scene object from a plurality of scene beat objects.

3. The computer readable storage medium of claim 1, further comprising:
instructions for playing a story formed by the scene object.

4. The computer readable storage medium of claim 1, further comprising:
instructions for streaming a professionally produced show to a computing system, wherein a story formed by the scene object is included in an environment of a professionally produced show.

5. The computer readable storage medium of claim 1, further comprising:
instructions for receiving a selection of a theme for a story formed by the scene object, wherein the theme is selected from a group of themes, wherein the group of themes is set by an administrator associated with a professionally produced show.

6. The computer readable storage medium of claim 1, further comprising:
instructions for selecting at least one multimedia object that includes information indicative of a scene introduction based on the selection of a plot scenario.

7. The computer readable storage medium of claim 1, further comprising:
instructions for selecting at least one multimedia object that includes information indicative of conflict for a scene based on the selection of a plot scenario.

8. The computer readable storage medium of claim 1, further comprising:
instructions selecting at least one multimedia object that information indicative of a conflict resolution based on the selection of a plot scenario.

9. The computer readable storage medium of claim 1, further comprising:
instructions selecting at least one multimedia object that includes information indicative of a scene transition based on the selection of a plot scenario.

10. The computer readable storage medium of claim 1, further comprising:
instructions for assembling a scene beat object by linking the selected cast member object and the received script object together with a video object.

11. The computer readable storage medium of claim 1, further comprising:
instructions for assembling a scene beat object by linking the selected cast member object and the received script object together with a sound object.

12. The computer readable storage medium of claim 1, further comprising:
instructions for storing an instance of the cast member object and an instance of the received script object in a single scene beat object file.

13. The computer readable storage medium of claim 1, further comprising:
instructions for storing an instance of the scene beat object and the at least one other scene beat object in a single scene object file.

14. The computer readable storage medium of claim 1, further comprising:
instructions for assembling an episode object from the scene object and a second scene object.

15. The computer readable storage medium of claim 1, further comprising:
instructions for receiving a selection of a play order for the scene beat object and at least one other scene beat object

16. A content distribution system, comprising:
circuitry for streaming a professionally produced show to a remote computing system; and
circuitry for sending a story formed from a scene object to the remote computing system, wherein the story formed from the scene object exists in an environment of the professionally produced show.

17. The system of claim 16, wherein the circuitry for sending the story further comprises:
circuitry for executing the scene object and sending a data stream indicative of the story to the remote computing system.

18. The system of claim 16, wherein the circuitry for sending the story further comprises:
circuitry for sending the scene object to the remote computer system, wherein the remote computer system is configured to execute the scene object and display the story.

19. The system of claim 16, further comprising:
circuitry for assembling the scene object from a plurality of scene beat objects.

20. The system of claim 16, wherein the circuitry for sending the story further comprises:
circuitry for sending a story formed from the scene object and a least one additional scene object.

21. The system of claim 16, wherein the story includes video.

22. The system of claim 16, wherein the story includes text.

23. The system of claim 16, wherein the story includes audio.

24. The system of claim 16, further comprising:
circuitry for sending a profile for a cast member in the story to the remote computing system.

25. The system of claim 16, further comprising:
circuitry for adjusting a rating for the story based on information received from the remote computing system.

26. The system of claim 16, further comprising:
circuitry for linking the scene object to the professionally produced show.

27. The system of claim 16, further comprising:
circuitry for sending a contact request from a user associated with the computing system to a user account associated with a cast member in the story.

28. The system of claim 16, further comprising:
circuitry for linking a second scene object created by a user associated with the computing system to the scene object.

29. The system of claim 16, further comprising:
circuitry for linking a second scene object created by the user associated with the computing system to the scene object, wherein the second scene object is a version of the story.

30. An interactive content story driven system, comprising:
means for receiving a selection of a cast member object to fill an unfilled role in a scene object; and
means for storing the scene object.

31. The system of claim 30, further comprising:
means for receiving a signal approving the selection of the cast member object from a user account associated with the cast member object.

32. The system of claim 30, further comprising:
means for searching a database of character member objects.

33. The system of claim 30, wherein the means for receiving the selection of the cast member object further comprise:
means for receiving the selection of the cast member object, wherein an audition was held to cast the cast member object for the unfilled role.

34. The system of claim 30, wherein the means for receiving the selection of the cast member object further comprise:
means for receiving the selection of the cast member object, wherein cast member object includes a character trait requested by the author of the scene object.

35. The system of claim 30, wherein the means for receiving the selection of the cast member object further comprise:
means for receiving the selection of the cast member object, wherein the cast member object includes a character profession requested by the author of the scene object.

36. The system of claim 30, wherein the means for receiving the selection of the cast member object further comprise:
means for receiving the selection of the cast member object, wherein the cast member object is a member of a group requested by the author of the scene object.

37. The system of claim 30, further comprising:
means for streaming a professionally produced show to a computing system, wherein the scene object exists in an environment of the professionally produced show.

38. The system of claim 30, further comprising:
means for streaming a story formed by the scene object to a computing system.

39. The system of claim 30, further comprising:
means for linking a second scene object to the scene object, wherein the second scene object was created by a user that created the cast member object.

40. The system of claim 30, further comprising:
means for linking a second scene object to the scene object, wherein the second scene object is a version of a story formed from the scene object.

41. A multiple-narrative story method, comprising:
publishing a professionally produced episode of a show that includes a global event; and
linking a scene object to the produced episode of the show, wherein the scene object describes a story that takes place during the global event.
